(19) United States
(12) Patent Application Publication
(10) Pub. No.: US 2016/0248096 A1
(43) Pub. Date: Aug. 25, 2016

(54) Lithium Battery Incorporating Tungsten Disulfide Nanotubes

(71) Applicant: N1 Technologies Inc., Daytona Beach, FL (US)

(72) Inventor: Roc Hatfield, Safety Harbor, FL (US)

(21) Appl. No.: 15/048,593

(22) Filed: Feb. 19, 2016

Related U.S. Application Data
(60) Provisional application No. 62/118,016, filed on Feb. 19, 2015.

(51) Int. Cl. H01M 4/62; H01M 10/0585; H01M 4/134; H01M 10/052

(52) U.S. Cl. CPC H01M 4/624; H01M 10/052; H01M 10/0585; H01M 4/134; H01M 2004/027

(57) ABSTRACT

A lithium battery incorporating tungsten disulfide nanotubes is a battery which improves upon the capacitance and charge times of traditional lithium batteries through the inclusion of tungsten disulfide nanotubes. For a traditional galvanic cell including an anode, a cathode, a porous membrane, a quantity of electrolyte solution and an electrically insulated enclosure, the additional inclusion of a plurality of tungsten disulfide nanotube improves upon traditional lithium batteries due to the increased surface area and favorable electrical properties, such as electron density and capacitance, of tungsten disulfide nanotubes over previously incorporated metals. The anode, the cathode, the porous membrane and the quantity of electrolyte solution facilitate an oxidation-reduction reaction in order to produce an electric current to be output to an external electrical circuit.

The current application claims a priority to the U.S. Provisional Patent application Ser. No. 62/118,016 filed on Feb. 19, 2015.

### FIELD OF THE INVENTION

The present invention relates generally to a battery. More specifically, the present invention relates to a lithium battery incorporating tungsten disulfide nanotube as an improvement on current lithium ion battery technology.

### BACKGROUND OF THE INVENTION

Current anode storage materials used in lithium ion battery technologies take a fair amount of time to charge to capacity, while the charge depletes very quickly when a load is placed on the battery.

The present invention is a lithium battery incorporating tungsten disulfide nanotubes. Through the incorporation of nanotubes, the present invention increases capacitance by exponentially increasing the surface area for electron transfer through the battery cell. The increased surface area allows for faster charge rates and an increase in electron density for a longer lasting overall battery charge.

### BRIEF DESCRIPTION OF THE DRAWINGS

FIG. 1 is a perspective view of the present invention.

FIG. 2 is a side cross-sectional view of the present invention along line 2-2 of FIG. 1.

FIG. 3 is an electrical schematic diagram of the present invention.

FIG. 4 is an illustration of the cylindrical lattice structure for each of the plurality of tungsten disulfide nanotubes.

FIG. 5 is an illustration of a tungsten disulfide nanotube being concentrically positioned within another tungsten disulfide nanotube.

### DETAIL DESCRIPTIONS OF THE INVENTION

All illustrations of the drawings are for the purpose of describing selected versions of the present invention and are not intended to limit the scope of the present invention.

The present invention is a lithium battery incorporating tungsten disulfide nanotubes. The present invention improves upon traditional lithium batteries through the inclusion of tungsten disulfide nanotubes to store and transfer electrons more effectively. Tungsten disulfide on the nano-scale exhibits electrical conductivity and capacity properties favorable for battery applications. Theoretically, tungsten disulfide and similar metallic nanotubes can carry an electrical current density of approximately four giga-amperes per centimeter squared, roughly one thousand times greater than other metals due to limits of electron migration through the material. Thus, the present invention is ideal for portable power applications by providing a battery with faster recharge rates and extended charge capacity.

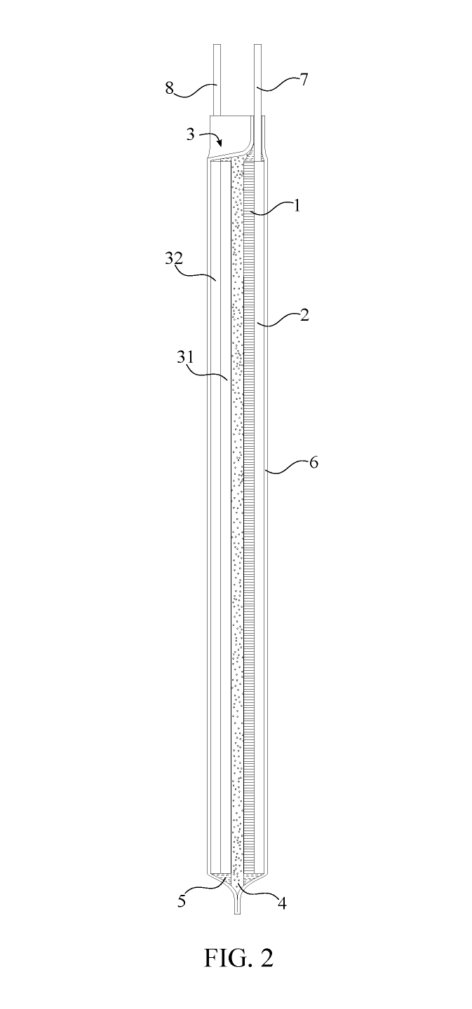

In accordance to FIG. 2, the present invention comprises a plurality of tungsten disulfide nanotubes 1, an anode 2, a cathode 3, a porous membrane 4, a quantity of electrolyte solution 5, and an electrically-insulated enclosure 6. The plurality of tungsten disulfide nanotubes 1, the anode 2, the cathode 3, and the porous membrane 4 are submerged in the quantity of electrolyte solution 5, where the quantity of electrolyte solution 5 is a medium for electrical flow and contains ions for an oxidation-reduction reaction to occur. The quantity of electrolyte solution 5 is contained within the electrically-insulated enclosure 6, along with the plurality of tungsten disulfide nanotubes 1, the anode 2, the cathode 3, and the porous membrane 4, in order to prevent loss of the quantity of electrolyte solution 5. The anode 2, the cathode 3, the porous membrane 4, and the quantity of electrolyte solution 5 produce a galvanic cell.

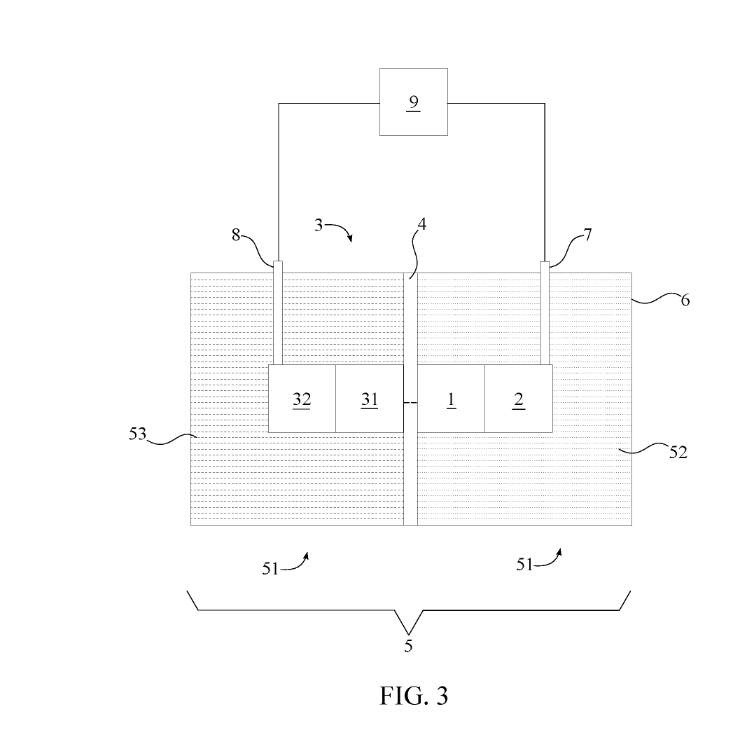

In accordance to FIG. 3, the galvanic cell allows for the facilitation of the oxidation-reduction reaction for the ions of the quantity of electrolyte solution 5 to react in order to produce electricity when an external electrical circuit 9 is complete. Half of the chemical reaction occurs at the anode 2, the negatively charged terminal, where electrons are produced and output to the external electrical circuit 9. The electrons pass through the porous membrane 4 to the cathode 3, the positively charged terminal, where the electrons facilitate the second half of the chemical reaction and current is received from the external electrical circuit 9. The porous membrane 4 is mounted within the electrically-insulated enclosure 6 in order to delineate half-cells of the galvanic cell for each of the half reactions of the oxidation-reduction reaction to occur. The porous membrane 4 separates the anode 2 and the cathode 3 from being in fluid contact from each other in order to prevent the reaction from spontaneously occurring; however, the porous membrane 4 allows the flow of ions to be exchanged between each of the half cells to allow the reaction to occur when the external electrical circuit 9 is completed.

The plurality of tungsten disulfide nanotubes 1 allows for an additional capacitance of electrons to be stored within the present invention. The plurality of tungsten disulfide nanotubes 1 is adhered across the anode 2 in order to collect electrons which are produced by the oxidation-reduction reaction at the anode 2, in accordance to FIG. 2. The plurality of tungsten disulfide nanotubes 1 is pressed against the porous membrane 4 in order to reduce the distance between the plurality of tungsten disulfide nanotubes 1 and the cathode 3, and therefore reducing the resistance of electrical flow through the quantity of electrolyte solution 5. The cathode 3 is similarly pressed against the porous membrane 4, opposite to the plurality of tungsten disulfide nanotubes 1 in order to reduce the resistance of electrical flow through the quantity of electrolyte solution 5.

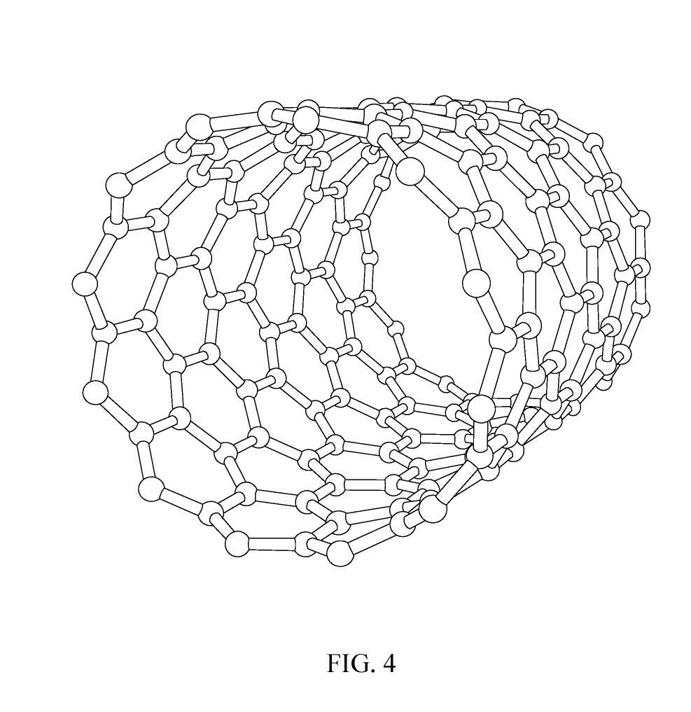

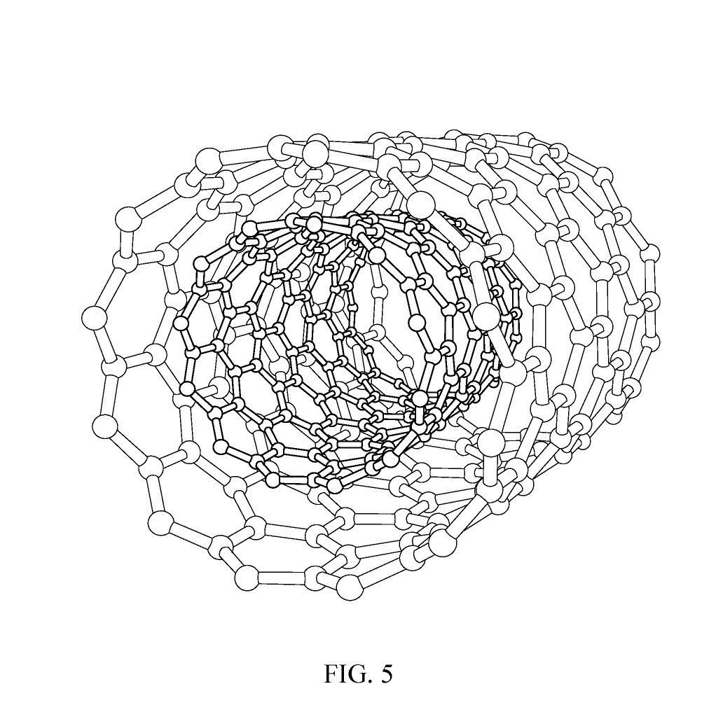

In accordance to the preferred embodiment of the plurality of tungsten disulfide nanotubes 1, each of the plurality of tungsten disulfide nanotubes 1 is preferably configured as a cylindrical lattice structure, as detailed in FIG. 4. The cylindrical lattice structure provides a large surface area per weight which increase the rate at which electrons can be transferred to and from the plurality of tungsten disulfide nanotubes 1. Each of the plurality of tungsten disulfide nanotubes 1 is preferred to have a diameter between five and eight nanometers and a length between ten and twelve nanometers. These dimensions provide sufficient transfer and capacitance of electrons while being able to mass the plurality of tungsten disulfide nanotubes 1 onto the anode 2. In some embodiments of the plurality of tungsten disulfide nanotubes 1, a fraction of the plurality of tungsten disulfide nanotubes 1 is concentrically positioned within each other, as shown in FIG. 5. Therefore, exponentially increasing the storage capacity and transfer rate of electrons through the plurality of tungsten disulfide nanotubes 1 by increasing the channels and mass which electrons are able to be transferred through.

In accordance to the preferred embodiment of the present invention, the quantity of electrolyte solution 5 is a redox pair of non-aqueous, non-coordinating lithium salt solutions 51, wherein the resdox pair of non-aqueous, non-coordinating lithium salt solutions comprises an oxidation solution 52 and a reduction solution 53, as shown in FIG. 3. The oxidation solution 52 and the reduction solution 53 correspond to half-reactions of reversible chemical reactions appropriate for rechargeable lithium batteries. The oxidation solution 52 and the reduction solution 53 are separated from each other by the porous membrane 4 such that the oxidation-reduction reaction does not occur spontaneously. The anode 2 and the plurality of tungsten disulfide nanotubes 1 are submerged in the oxidation solution 52, while the cathode 3 is submerged in the reduction solution 53 in order for the oxidation-reduction reaction to produce a predictable electric current pattern.

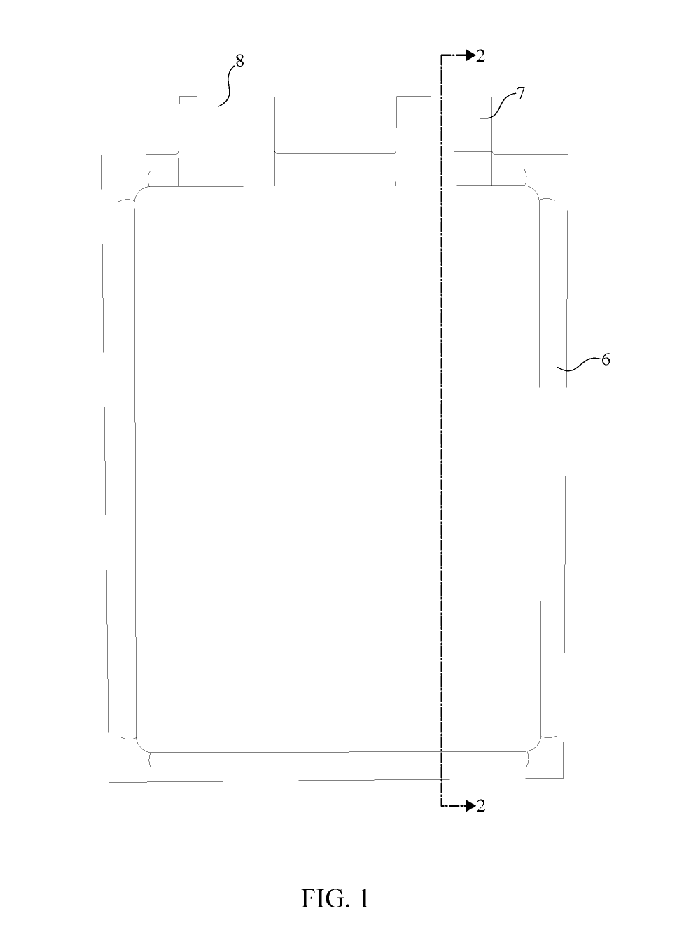

Further in accordance to the preferred embodiment of the present invention, the present invention comprises a first electrical lead 7 and a second electrical lead 8, as shown in FIG. 1 to FIG. 3. The first electrical lead 7 and the second electrical lead 8 allow the present invention to be easily integrated into an external electrical circuit 9. The first electrical lead 7 is electrically connected to the anode 2. The first electrical lead 7 is, therefore, the negative terminal of the present invention as electrons are produce at the anode 2 and distributed to the external electrical circuit 9 through the first electrical lead 7. The second electrical lead 8 is electrically connected to the cathode 3. The second electrical lead 8 is, therefore, the positive terminal of the present invention as electrons are received by the cathode 3 from the external electrical circuit 9 through the second electrical lead 8. The first electrical lead 7 and the second electrical lead 8 sealably traverse out of the electrically-insulated enclosure 6 in order to be integrated into the external electrical circuit 9 in order to retain the quantity of electrolyte solution 5 within the electrically-insulated enclosure 6.

Still in accordance to the preferred embodiment of the present invention, the anode 2 is preferred to be made of copper due to copper's electrical conductivity. The plurality of tungsten disulfide nanotubes 1 is applied using a fast drying adhesive to a copper foil before being assembled into the complete present invention.

Further in accordance to the preferred embodiment, the cathode 3 comprises an electrolysis interface 31 and a current collector 32. The electrolysis interface 31 is where the reduction half reaction occurs. The electrolysis interface 31 is preferably made of porous lithium in order to provide a suitable material for the chemical reaction to occur as well as sufficient surface area to maximize the reaction rate and electron transfer. The electrolysis interface 31 is pressed against the porous membrane 4 to reduce the resistance to electron flow to the plurality of tungsten disulfide nanotubes 1 by the quantity of electrolyte solution 5. The current collector 32 is a sufficient metal for electrons travel along to be transferred from the electrolysis interface 31 to the external electrical circuit 9. The current collector 32 is preferably made from aluminum. The current collector 32 is pressed against the electrolysis interface 31 in order to receive the current produced from the oxidation-reduction reaction.

Although the invention has been explained in relation to its preferred embodiment, it is to be understood that many other possible modifications and variations can be made without departing from the spirit and scope of the invention as hereinafter claimed.

What is claimed is:

1. A lithium battery incorporating tungsten disulfide nanotubes comprises:
a plurality of tungsten disulfide nanotubes;
an anode;
a cathode;
a porous membrane;
a quantity of electrolyte solution;
an electrically-insulated enclosure;
the porous membrane being mounted within the electrically-insulated enclosure;
the plurality of tungsten disulfide nanotubes being adhered across the anode;
the plurality of tungsten disulfide nanotubes being pressed against the porous membrane;
the cathode being pressed against the porous membrane, opposite to the plurality of tungsten disulfide nanotubes;
the quantity of electrolyte solution being contained within the electrically-insulated enclosure; and
the plurality of tungsten disulfide nanotubes, the anode, the porous membrane, and the cathode being submerged into the quantity of electrolyte solution.

2. The lithium battery incorporating tungsten disulfide nanotubes, as claimed in claim 1, comprises:
the electrolyte solution being a redox pair of non-aqueous, non-coordinating lithium salt solutions;
the redox pair of non-aqueous, non-coordinating lithium salt solutions comprises an oxidation solution and a reduction solution;
the oxidation solution and the reduction solution being separated from each other by the porous membrane;
the anode and the plurality of tungsten disulfide nanotubes being submerged in the oxidation solution; and
the cathode being submerged in the reduction solution.

3. The lithium battery incorporating tungsten disulfide nanotubes, as claimed in claim 1, comprises:
a first electrical lead;
a second electrical lead;
the first electrical lead being electrically connected to the anode;
the second electrical lead being electrically connected to the cathode; and
the first electrical lead and the second electrical lead sealably traverse out of the electrically-insulated enclosure.

4. The lithium battery incorporating tungsten disulfide nanotubes, as claimed in claim 1, wherein the anode is made of copper.

5. The lithium battery incorporating tungsten disulfide nanotubes, as claimed in claim 1, comprises:
the cathode comprises an electrolysis interface and a current collector;
the electrolysis interface being pressed against the porous membrane; and
the current collector being pressed against the electrolysis interface opposite to the porous membrane.

6. The lithium battery incorporating tungsten disulfide nanotubes, as claimed in claim 5, wherein the electrolysis interface is porous.

7. The lithium battery incorporating tungsten disulfide nanotubes, as claimed in claim 5, wherein the electrolysis interface is made of lithium.

8. The lithium battery incorporating tungsten disulfide nanotubes, as claimed in claim 5, wherein the current collector is made of aluminum.

9. The lithium battery incorporating tungsten disulfide nanotubes, as claimed in claim 1, wherein each of the plurality of tungsten disulfide nanotubes is configured as a cylindrical lattice structure.

10. The lithium battery incorporating tungsten disulfide nanotubes, as claimed in claim 1, wherein a fraction of the plurality of tungsten disulfide nanotubes is concentrically positioned within each other.

11. The lithium battery incorporating tungsten disulfide nanotubes, as claimed in claim 1, wherein a diameter for each of the plurality of tungsten disulfide nanotubes is between five nanometers and eight nanometers.

12. The lithium battery incorporating tungsten disulfide nanotubes, as claimed in claim 1, wherein a length for each of the plurality of tungsten disulfide nanotubes is between ten nanometers to twelve nanometers.

13. A lithium battery incorporating tungsten disulfide nanotubes comprises:
a plurality of tungsten disulfide nanotubes;
an anode;
a cathode;
a porous membrane;
a quantity of electrolyte solution;
an electrically-insulated enclosure;
a first electrical lead;
a second electrical lead;
the porous membrane being mounted within the electrically-insulated enclosure;
the plurality of tungsten disulfide nanotubes being adhered across the anode;
the plurality of tungsten disulfide nanotubes being pressed against the porous membrane;
the cathode being pressed against the porous membrane, opposite to the plurality of tungsten disulfide nanotubes;
the quantity of electrolyte solution being contained within the electrically-insulated enclosure;
the plurality of tungsten disulfide nanotubes, the anode, the porous membrane, and the cathode being submerged into the quantity of electrolyte solution;
the first electrical lead being electrically connected to the anode;
the second electrical lead being electrically connected to the cathode; and
the first electrical lead and the second electrical lead sealably traverse out of the electrically-insulated enclosure.

14. The lithium battery incorporating tungsten disulfide nanotubes, as claimed in claim 13, comprises:
the electrolyte solution being a redox pair of non-aqueous, non-coordinating lithium salt solutions;
the redox pair of non-aqueous, non-coordinating lithium salt solutions comprises an oxidation solution and a reduction solution;
the oxidation solution and the reduction solution being separated from each other by the porous membrane;
the anode and the plurality of tungsten disulfide nanotubes being submerged in the oxidation solution; and
the cathode being submerged in the reduction solution.

15. The lithium battery incorporating tungsten disulfide nanotubes, as claimed in claim 13, wherein the anode is made of copper.

16. The lithium battery incorporating tungsten disulfide nanotubes, as claimed in claim 13, comprises:
the cathode comprises an electrolysis interface and a current collector;
the electrolysis interface being pressed against the porous membrane; and
the current collector being pressed against the electrolysis interface opposite to the porous membrane.

17. The lithium battery incorporating tungsten disulfide nanotubes, as claimed in claim 13, wherein each of the plurality of tungsten disulfide nanotubes is configured as a cylindrical lattice structure.

18. The lithium battery incorporating tungsten disulfide nanotubes, as claimed in claim 13, wherein a fraction of the plurality of tungsten disulfide nanotubes is concentrically positioned within each other.

19. The lithium battery incorporating tungsten disulfide nanotubes, as claimed in claim 13, wherein a diameter for each of the plurality of tungsten disulfide nanotubes is between five nanometers and eight nanometers.

20. The lithium battery incorporating tungsten disulfide nanotubes, as claimed in claim 13, wherein a length for each of the plurality of tungsten disulfide nanotubes is between ten nanometers to twelve nanometers.
